(19) United States
(12) Patent Application Publication
(10) Pub. No.: US 2007/0254205 A1
(43) Pub. Date: Nov. 1, 2007

(54) POLYMER FUEL CELL AND SEPARATOR

(76) Inventors: Katsunori Nishimura, Hitachiota (JP); Yuki Okuda, Hitachi (JP); Jinichi Imahashi, Hitachi (JP); Hideki Shinohara, Hitachiota (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/740,951

(22) Filed: Apr. 27, 2007

(30) Foreign Application Priority Data
Apr. 27, 2006 (JP) 2006-122876

(51) Int. Cl. H01M 8/02; H01M 4/94

(52) U.S. Cl. 429/39; 429/38; 429/44

(57) ABSTRACT

A polymer electrolyte fuel cell comprising a first separators for oxidizing gas and a second separator for fuel gas and a membrane/electrode assembly sandwiched between the separators. A first group of oxidizing gas flow passages flowing, from an entrance towards a turning point, has the longer length than a second group of oxidizing gas flow passages. The second group of flow passages, from the turning point towards an exit, are formed on the plane of the first separator. A downstream of the flow passages of the first group is located near an upper stream of the flow passages of the second. The flow passages of the first group and flow passages of the second group adjoin one another on the plane of the first separator.

### CLAIM OF PRIORITY

The present application claims priority from Japanese application serial No. 2006-122876, filed on Apr. 27, 2006, the content of which is hereby incorporated by reference into this application.

### FIELD OF THE INVENTION

The present invention relates to a polymer fuel cell that is capable of generating electric power without disposing a humidifier to an exterior of the fuel cell and an electric appliance using the same.

### RELATED ART

Polymer fuel cells have such advantages that they are easy to start and stop because they are high in electric power generation and have a long service life. Therefore, it is expected to use them in a wide application such as power sources for automobiles, business and home distributed power sources, etc.

Among the applications the distribution power sources, which have the polymer fuel cell (co-generation power system, for example) are the system that generate electricity by the polymer fuel cell and recover heat produced by the fuel cell as hot water thereby to efficiently use energy. The distribution power sources are operated for 50,000 to 100,000 hours as a service life. In order to achieve the target, developments of membrane/electrode assemblies, cell structures, power generation conditions have been conducted.

As the membrane/electrode assemblies an electrolyte membrane that is permeable to hydrogen ions or protons is used. The electrolyte membrane must retain water therein to thereby make hydrogen ions move easily. If the membrane is too dry, the movement of hydrogen ions is suppressed to decrease a cell voltage.

In principle, when reaction water is produced by electric power generation, water is absorbed in the membrane to remove the above problem. If dry air is introduced into the cell, though at the downstream of the gas flow drying of the membrane is avoided by absorbing product water, drying of the membrane proceeds at the upper stream of gas flow because of shortage of water. Thus, there remains a difficult problem in omitting the humidifier.

Accordingly, in the conventional technology, the drying of the membrane at the upper stream of the gas flow has been avoided by supplying a mixture of fuel or oxidizing gas and optimum steam to the fuel cell. For example, in the conventional humidifiers, there have been known a humidifier using hollow fibers (patent document No. 1), a humidifier using a water permeable membrane (patent document No. 2), a cell structure wherein water is added in the cell (patent document No. 3), etc.

### (Patent document No. 1); Japanese patent laid-open 2005-40675

### (Patent document No. 2); Japanese patent laid-open 2004-206961

### (Patent document No. 3); Japanese patent No. 3029416

However, according to the conventional technologies, it was necessary to provide a humidifier in the fuel cell or to dispose a water supply tank or a pump to the fuel cell. As a result, a total volume of the power generation apparatus becomes large because there are a space for auxiliary equipments for humidifying and space for the piping connecting the auxiliary equipments and the fuel cell.

According to the conventional technologies, if non-humidified gas is introduced into the fuel cell, which omits the humidifier, the electrolyte membrane tends to be dried at the upper stream of the gas flow, resulting in decrease of a cell voltage. Particularly, if air is used as the oxidizing gas, the drying of the membrane is remarkable since a gas flow volume is three times the amount of fuel gas.

### SUMMARY OF THE INVENTION

Therefore, it is an object of the present invention to provide a fuel cell and a fuel cell system that are capable of generating electric power at a stable voltage. If water produced in the fuel cell can be circulated or recycled in the fuel cell, spaces for the auxiliary equipments can be omitted or minimized.

The present invention provides a polymer fuel cell having a separator for separating fuel gas from oxidizing gas and a polymer electrolyte membrane, wherein oxidizing gas flow passages are formed extending from a manifold of the separator and wherein the oxidizing gas flow passages have lengths defined by a start point of the oxidizing gas flow passages that contact and communicates with the manifold is different from that of an adjoining oxidizing gas flow passage.

According to the present invention, it is possible to provide a fuel cell for an electric power generation apparatus with a downsized auxiliary device for humidifying the fuel cell or without having the humidifying auxiliary devices.

Accordingly, the present invention provides a polymer electrolyte fuel cell comprising a first separators for oxidizing gas and a second separator for fuel gas and a membrane/electrode assembly sandwiched between the separators, wherein a first group of oxidizing gas flow passages flowing, from an entrance towards a turning point, having the longer length than a second group of oxidizing gas flow passages, from the turning point towards an exit, are formed on a plane of the first separator, wherein a downstream of the flow passages of the first group is located near an upper stream of the flow passages of the second, and wherein the flow passages of the first group and flow passages of the second group adjoin one another on the plane of the first separator.

In the above polymer electrolyte fuel cell, the length of the first group of flow passages is defined by a length from the entrance for the oxidizing gas to the turning point and the length of the second group of flow passages is defined by a length from the turning point to the exit.

The flow passages of the first group and the flow passages of the second group are alternately arranged so that the flow passages having a longer length (in humid state) and the flow passages having a shorter length (dry state) adjoin one another. The longer flow passages containing product water give water to adjoining flow passages containing relatively dry oxidizing gas.

The water in the flow passages of the first group is transferred through a gas diffusion layer in contact with the separator and through the membrane to the flow passages of the first group.

### BRIEF DESCRIPTION OF THE DRAWINGS

FIG. 1 shows an oxidizing gas separator of an embodiment of the present invention, wherein FIG. 1(b) shows a face of oxidizing gas flow passages, FIG. 1(a) a reverse side, FIG. 1(c) a cross sectional view of the separator along A-A in FIG. 1(b) and FIG. 1(d) an enlarged plane view of X in FIG. 1(b).

FIG. 2 shows a fuel gas separator of the embodiment of the present invention, wherein FIG. 2(a) shows a face of fuel gas flow passage and FIG. 2(b) a cross sectional view along B-B in FIG. 2(a).

FIG. 3 shows a cooling water separator of the embodiment of the present invention, which shows a face of cooling water flow passages.

FIG. 4 shows a fuel cell stack of the embodiment of the present invention, wherein FIG. 4(b) is a cross sectional view of the stack and FIG. 4(a) an enlarged cross sectional view of Y in FIG. 4(b).

FIG. 5 shows a separator of a comparative oxidizing gas, wherein FIG. 5(a) is a reverse face of the separator, FIG. 5(b) a plane view of flow passages of the separator, FIG. 5(c) a cross sectional view along C-C in FIG. 5(b), and FIG. 5(d) an enlarged view of X in FIG. 5(b). In the comparative separator, the flow passages for oxidizing gas have no turning points shown in FIG. 1(b). Accordingly, the length of the flow passages are all the same. Therefore, end portions of the flow passages are humid, but they do not adjoin dry flow passages. Thus, the humid flow passages do not water to the fry flow passages.

### DETAILED DESCRIPTION OF THE PREFERRED EMBODIMENTS

In this embodiment, product water is supplied to a dried portion at an upper part of the gas flow passages, (1) from a humid portion of the flow passages at lower part of the flow passages, and/or (2) from an electrolyte membrane and/or a gas diffusion layer.

In order to realize the above, (1) the upper part (start points) of the flow passages and the lower passages (endpoints) are adjoined; (2) the flow passages have turning points where the gas in the upper flow change their flow direction towards the start points; (3) the gas that returns at the turning points flows into flow passages between the flow passages of the upper stream so that flow passages for dry gas and flow passages for humid gas adjoin to transfer water therebetween.

The water may be recovered from the electrolyte membrane in a lower stream of gas flow passages, wherein the upper stream and lower stream of the oxidizing gas are adjoined. In order to realize this system, a new separator was invented wherein the upper gas flow passage (dry flow passages) of the separator and the lower gas flow passages (humidified flow passages) are adjoined. This separator having the above structure is called “dry-humid parallel flow passages” in the present specification.

A fuel cell according to the embodiment has a cell stack structure of a unit cell or a plurality of cells, each of which is constituted by at least two types of separators each having fuel gas flow passages or oxidizing gas flow passages for sandwiching a membrane/electrode assembly.

As fuel gas, gas containing hydrogen such as reformed gas, pure hydrogen, etc can be used. As oxidizing gas, oxygen or air can be used.

As the separator, the separator having the “dry-humid parallel flow passages” is used. In the following the structure is explained in detail by reference to drawings.

In order to omit the humidifier, it is necessary to prevent drying of the electrolyte membrane caused by flowing dry gas before power generation. Especially, when air is used as the oxidizing gas, an oxygen concentration is as low as 21% by volume, and a volume of air consumed is large. Therefore, the condition of wetness of the electrolyte membrane is largely affected. On the other hand, a large amount of water is present in the gas as the product water as steam at the downstream of the oxidizing gas flow passages, which, normally, flows out from the fuel cell.

In the present invention, the product water, which is to flow out from the fuel cell, is recycled within the fuel cell to supply water to the upper stream where the electrolyte membrane tends to be dried.

As one method of recycling of product water, there is a method wherein dry gas flow passages, which correspond to the upper gas flow passages of the oxidizing gas, and humid gas flow passages, which correspond to the downstream gas flow passages of the oxidizing gas are adjoined whereby the product water moves from the humid gas flow passage side to the dry gas flow passage side that adjoin the humid gas flow passages.

The dry gas flow passages and humid gas flow passages are relatively determined by dew points (steam partial pressures). In order to make it clearer, the “dry-humid parallel flow passages” of the present embodiment is defined by reference to the following definition.

In gas flow passages for introducing oxidizing gas from the manifold (supply manifold) into the flow passages (reaction flow passages) where reaction at the membrane/electrode assembly takes place, a start point is a start point of the flow passage (ends of flow passages), which is positioned at an entrance of the reaction flow passages. A length of the gas flow passage (flow passage length) along the gas flow from the start point is defined. Among the adjoining plural oxidizing gas flow passages, the flow passage lengths are compared; a shorter flow passage length is defined as a dry gas flow passage and a longer flow passage length is defined as a humid flow passage.

That the flow passage length from the start point is long means a reaction time of reduction of hydrogen on the membrane/electrode assembly is long. Thus, a large amount of product water produced by the reaction is taken into the oxidizing gas. Therefore, the longer the flow passage length, the higher the dew point of the oxidizing gas becomes high (a steam partial pressure is high). On the other hand, the shorter the flow passage length, the lower the dew point becomes low (steam partial pressure is low).

A cell structure of the present embodiment will be explained by reference to the flow passage length. In one of the structures of the present embodiment, a separator for flowing oxidizing gas is consisted by a plurality of flow passages, wherein flow passage lengths of at least one pair of flow passages in the adjoining flow passages are different. According to this structure, giving and receiving of water is carried out between the adjoining flow passages.

Giving and receiving of water is carried out through a porous gas diffusion layer sandwiched between the separator and the membrane/electrode assembly.

Another structure of the present embodiment, which satisfies the first structure, is featured by at least one pair of adjoining flow passages each having an opposite flow direction. After dry gas flows through a power generation flow surface and it returns at a turning point where there is the separator, the gas returns in the state, which contains steam so that it is easy to give water to downstream flow passages.

Further, in the third structure of the present embodiment, a groove width of one pair or more of the flow passages at an upper stream is not larger than that of the flow passages at downstream. Gas is dried in the upper stream, and a quantity of product water is still small (partial pressure of steam is small). If the groove width is large, an area of dried electrolyte membrane becomes large. Since a transfer speed of water in the membrane in a two dimensional direction (a lateral direction) is slow, drying of the membrane tends to proceed. Thus, if the groove width is large, a rate of evaporation of water into gas phase is too fast and drying of the electrolyte membrane tends to proceed.

On the other hand, if the groove width is small, supply of water from the adjoining flow passages at downstream becomes sufficient. The width of the flow passages at the upper stream is preferably 2 mm or less, particularly 0.5 to 1 mm is more preferable.

On the other hand, a groove width of the flow passages at a lower stream is 2 mm or less, it is preferable to make the groove width slightly larger than that at the upper stream. The purpose of this structure is to supply a larger amount of water to the electrolyte membrane by securing a contact face between the electrolyte membrane and gas containing product water.

Lastly, a fourth structure of the present embodiment is featured by superimposing a flow passage of the fuel gas flow passages at a downstream on an entrance portion of the flow passages of the oxidizing gas.

The oxidizing gas is separated from the fuel gas by the membrane/electrode assembly. The membrane has a very small thickness of as small as several ten micrometers, and has functions for retaining and releasing water. As a result, as the power generation progresses along the flow passages, an amount of product water (steam partial pressure) in the oxidizing gas increases to make an amount of water retained in the membrane.

If fuel gas is dried on the opposite face, water is deprived of from the membrane. This is called “osmotic water”.

Absorbed water can move together with the fuel gas. If flow passages are formed in the separator so that fuel gas flows from upper side to the lower side and oxidizing gas flows from the lower side to the upper side. As the length of the oxidizing gas flow passages increases, an amount of product water increases and the product water can be supplied from the oxidizing gas to the fuel gas at the upper stream of the fuel gas stream. Then, since the fuel gas flows downward along the flow passages, the adsorbed water moves in the vicinity of the upper stream with respect to the oxidizing gas. As mentioned above, when the fourth structure of the present embodiment, it is possible to realize a large water recycle in the fuel cell as a whole.

The concept of the embodiment of the present invention will be explained in detail.

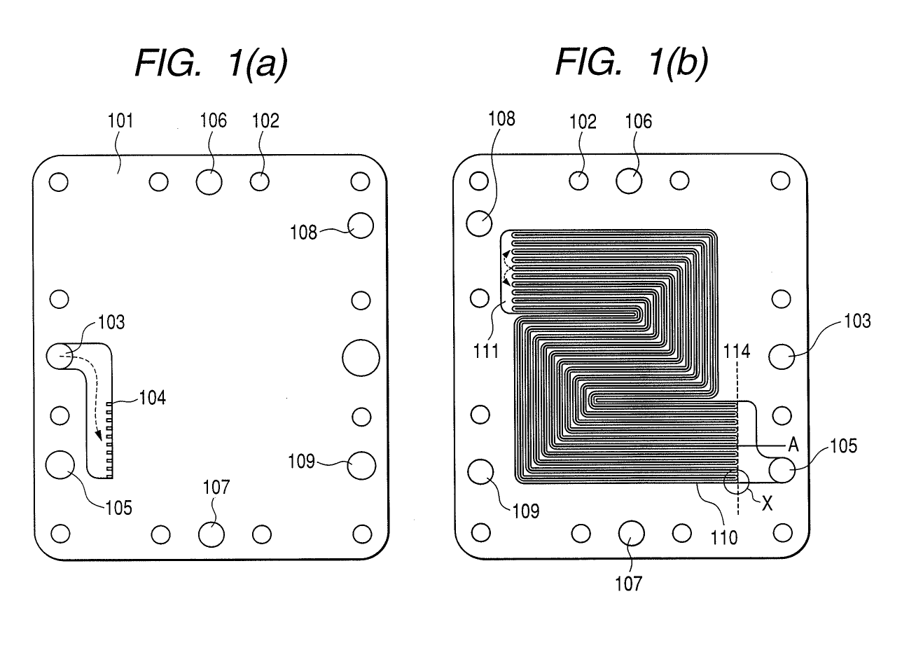

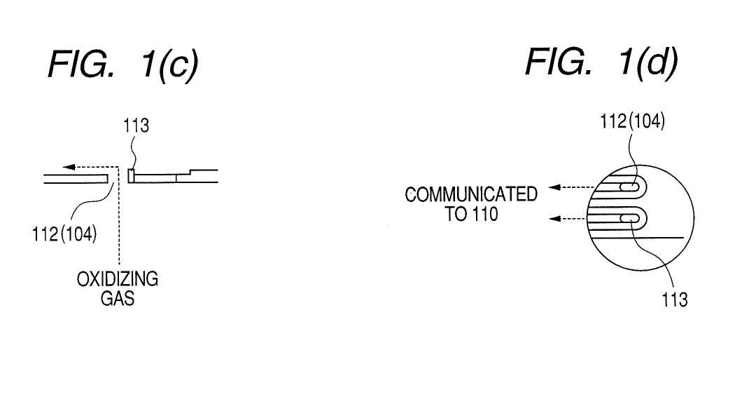

The oxidizing gas (hereinafter referred to as air) is supplied from a manifold 103 of the separator 101 at the oxidizing gas entrance and flows to a through hole 112 in FIG. 1(c). In the figure, the flow is shown by a dotted line in FIG. 1(a), which is a back face of the separator shown in FIG. 1(b). The through hole 112 communicates with the flow passage 110 in the front face in FIG. 1(b) whereby the oxidizing gas is introduced into the flow passage 110 through the through hole 112 as shown by dotted line arrows in FIG. 1(c), which is an enlarged view of X in FIG. 1(b).

The oxidizing gas flows through flow passages with a meander form to arrive at a turning point 111 located at a left upper side in FIG. 1(b). During the flow, the gas receives hydrogen ions from the membrane/electrode assembly to produce water. An amount of steam in the gas gradually increases as it flows the flow passages 110.

In FIG. 1(b), the separator is further provided with an entrance manifold 106 for fuel gas, an exit manifold 107 for fuel gas and an exit manifold 108 for cooling water. The point 114 is a starting point of the flow passages and an end point.

At the turning point 111, the oxidizing gas flows into the adjoining flow passages and/or remote flow passages and goes through in an opposite direction. The shift flow of the oxidizing gas at the turning point 111 is shown by a dotted arrow in FIG. 1(b). After the turning, the oxidizing gas flow further undergoes reduction reaction to increase the amount of water as the reaction proceeds. At last, the oxidizing gas arrives at exit manifold 105 for the oxidizing gas through the reaction zone and is discharged outside the fuel cell.

A flow passage length of the oxidizing gas defined in this embodiment has a first flow portion where the oxidizing gas is introduced from the entrance manifold 105 into the reaction face, the first flow portion being a starting point 114 of the flow passage length, which is shown by a dotted line in FIG. 1(a).

The flow passage length in this embodiment differs among the adjoining flow passages. The largest difference in the flow passage length among the flow passages is present in the vicinity of the oxidizing gas entrance (i.e. starting point and end point 114).

The flow passage length of the way to the turning point at the start point is zero and the flow passage length of the way from the starting point to the end point is twice the length between starting point 114 and the turning point 111. The smallest difference in the flow passage length, on the other hand, is present at the vicinity of the entrance and exit of the turning point 111. As described above, the separator shown in FIGS. 1(a) through 1(d) has a structure wherein there is difference in the flow length between the adjoining flow passages in almost all area in the separator face.

An amount of product water gradually increases along the way to the turning point 111 and particularly just after at the turning point 111 the amount of steam in the way to the starting point 114 becomes large. In the separator in this embodiment, since the flow passage length differs among the adjoining flow passages, there is a difference in an amount of steam contained in the oxidizing gas among the flow passages. Especially, a steam partial pressure contained in air in the way to the starting point 114 becomes larger than that of the way to the turning point 111, which adjoins the way to the starting point 114. As a result, the product water is fed from the flow passage in the way to the starting point 114 to the flow passage in the way to the turning point 111, thereby to realize the water recycling.

An amount of air (dry) in the way to the turning point, wherein oxygen is not reacted, is large. Thus, it is preferable that a cross sectional area of the grooves in the way to the starting point (humid) is larger than that in the way to the turning point. However, the smaller the groove width, the shorter the water diffusion distance becomes, thereby to keep a content of water in the membrane. Accordingly, it is preferable to make the groove width of the flow passages in the way to the turning point smaller than that of the flow passages in the way to the starting point and to make the groove depth of the flow passages in the way to the turning point larger than that of the flow passages in the way to the starting point.

The groove width of the flow passages (humid) in the way to the starting point can be wider than the flow passages in the way to the turning point.

If an amount of steam generation is equal to an amount of oxygen consumption, which is calculated by electricity generated, or more on a volumetric basis, the groove cross sectional areas of the flow passages in both the way to the turning point and to the starting point can be the same. In this case, it is sufficient that the groove width of the flow passages in the way to the turning point is the same or larger than that of the flow passages in the way to the starting point.

It is necessary to arrange the flow passages in such a manner that the humid flow passages are located next to the dry flow passages so that water is fed easily from the humid side to the dry side. However, flow passages present on the opposite side should not always be in the relationship of dry-humid-dry. By adjoining the humid flow passages to the dry flow passages, an area where the flow passages are in the dry state is made relatively smaller than an area in the humid state, which is effective for preventing drying of the membrane. Further, if there are humid flow passages are present on both side of each flow passage, water feeding to the dry flow passages is easy. In this way, water recycles are realized between the adjoining flow passages. The separator having the flow passage structure of the present embodiment is called a dry-humid parallel flow passage separator.

A method of flowing gas is conducted by forming another gas entrance near the turning point 111 shown in FIG. 1(a) and an exit near the other entrance. That is, there are two entrances and two exits. Gas is introduced into each of the entrances, wherein gas flows flow in a direction opposite to each other. In this case, as the gas flow length increases, a dew point elevates and humid portion and dry portion are formed in each flow passage. As a result, as shown in FIG. 1, drying of the electrolyte membrane is avoided by transfer of water from the humid gas to dry gas.

From the above description, it is apparent that under the premise that the dry flow passages and humid flow passages are adjoined and that there is at least a part of the adjoining portions in the flow passages, it is possible to omit the humidifying section or humidifying auxiliary components or to downsize them. If there is a long humid flow passage along the dry flow passage, an amount of recycling water increases so that sufficient humidification of the dry flow passages is preferably achieved. Further, it is more preferable if there is always a humid flow passage on one side of each of the dry flow passages. If there are humid flow passages on both sides of each of the dry flow passages, the best result can be expected.

In addition to the above water recycling mechanism, it is possible to stably generate electric power at a higher voltage under non-humidifying condition by providing a water recycling mechanism using fuel gas flow.

In the membrane of the membrane/electrode assembly in the cell surface, when a steam partial pressure of the fuel gas is lower than a equilibrium steam partial pressure (a steam pressure of a gaseous phase, which is equal with a water amount absorbed in the membrane) of the membrane, water in the membrane evaporates into fuel gas. This water is one that is produced in the oxidizing gas on opposite side of the membrane/electrode assembly and permeates the membrane/electrode assembly. This is called reverse osmosis water. As the fuel gas moves from the upperstream to downstream of the flow passage, the reverse osmosis water gradually accumulates in the gas. As a result, the steam vapor pressure at the downstream of the fuel gas is highest, and in some case water drops may be formed in the flow passages.

Thus, by imposing the downstream of the fuel gas stream on the upperstream of the oxidizing gas stream, it is possible to feed water to dry air through the membrane/electrode assembly from the fuel gas flow passages. At this time, there are a process wherein water contained in the membrane of the membrane/electrode assembly evaporates and a process wherein water is fed as accompanying water when hydrogen ions move through the membrane during electric power generation. In any processes the air at the upper stream of the oxidizing gas is humidified. As described above, water recycling is realized in the whole separator.

The flow passage structure described above has, when applied to the oxidizing gas, an advantage of electric energy saving by omitting humidifier. In a fuel cell using hydrogen or hydrogen containing gas and air, the dry-humid parallel flow passage is applied to a separator of the air side. It is of course acceptable to apply the dry-humid flow passage to a separator of the fuel side. When oxygen is used instead of air, the structure of the present invention can be applied to a separator at the fuel side.

Further concrete explanation of examples will be made by reference to drawing. The present invention is not limited to the examples raised here.

FIGS. 1(a) to 1(d) show a structural example of a separator 101 for oxidizing gas having oxidizing gas flow passages 110 of separators for a fuel cell.

Oxidizing gas is introduced from an entrance manifold 103 in FIG. 1(a) and flows through small holes 104 for introducing oxidizing gas to an opposite side face of the separator in FIG. 1(a) to a side of the separator. The reason of employment of such the complicated structure is as follows. In the opposite side face of the separator, as shown in FIGS. 1(a) and 1(c), the oxidizing gas enters from a through hole 112 (same as 104) the flow passages and flows zigzag upwardly. A rib 113 is provided at the portion near the through hole so as to prevent leakage of the oxidizing gas to a returning flow passage. When the oxidizing gas arrives at the turning point 111 (diffusion area), oxidizing gas from the flow passages mixes together and goes through returning flow passages (flow passages to the starting point), which adjoins the flow passages to the turning flow passages thereby to flow in reverse direction and returns to the original (end point 114). In this manner, the present embodiment employs a dry-humid parallel flow passage structure wherein the flow passages to the returning point and the flow passages to the starting point alternately exist. By transferring water in the oxidizing gas in the flow passages to the turning point to the flow passages to the starting point, water recycling is realized. Then, the gas in the flow passages to the starting point arrives at the exit manifold 105 and is discharged from the cell.

The flow passages to the turning point in the oxidizing gas side have a groove width of 0.8 mm, a groove depth of 0.9 mm, and flow passages to the starting point have a groove width of 1 mm and a groove depth of 0.7 mm. The projection (rib) between the flow passages has a height of 1 mm at both fuel side and oxidizing side. Side walls of the grooves have inclined faces spread outwardly by 5 degrees at the top thereof.

Small holes 102 (there are 12 holes in the figures), which are formed along the outer periphery of the separator, are bolt-holes used for inserting bolts therethrough to fasten a fuel cell. Slightly large holes 108, 109 are respectively an exit manifold for cooling water and an entrance manifold for cooling water. FIG. 1(d) shows a cross sectional view along the line B-B′ in FIG. 1(a).

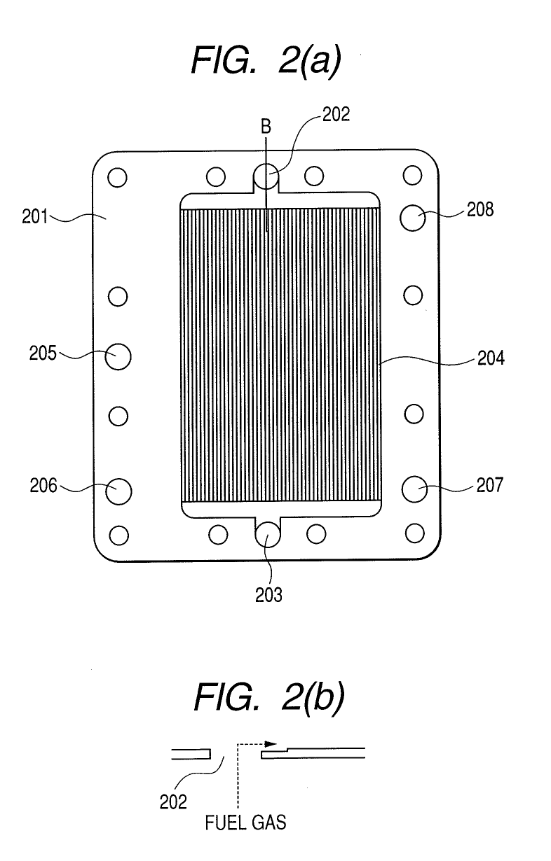

FIG. 2(a) shows a cross sectional view of a fuel gas separator 201 having flow passages for fuel gas.

Fuel gas is introduced from a fuel entrance manifold 202 to flow passages of the fuel gas separator and flows into the fuel gas flow passages 204. The fuel gas is consumed by oxidation in the flow passages and arrives at exit manifold 203 of fuel gas; then it is discharged from the cell. The separator 201 is further provided with an exit manifold 208 for cooling water, an entrance manifold 207 for cooling water, an exit manifold 206 for oxidizing gas, and an entrance manifold 205 for oxidizing gas.

A flow passage width of the fuel side is 1 mm and a groove depth is 0.5 mm. The flow passages are straight from the top to the bottom, where fuel gas is flown from the top to the bottom. A projection (rib) between the flow passages on fuel gas side and oxidizing gas side is 1 mm. The contour of the cross sectional area of the flow passages has a tapered form having an inclined angle of 5 degrees, the top of groove being broader than the bottom. The oxidizing separator 101 and the fuel separator 201 may be combined, one of which is on a front side and the other is on rear side.

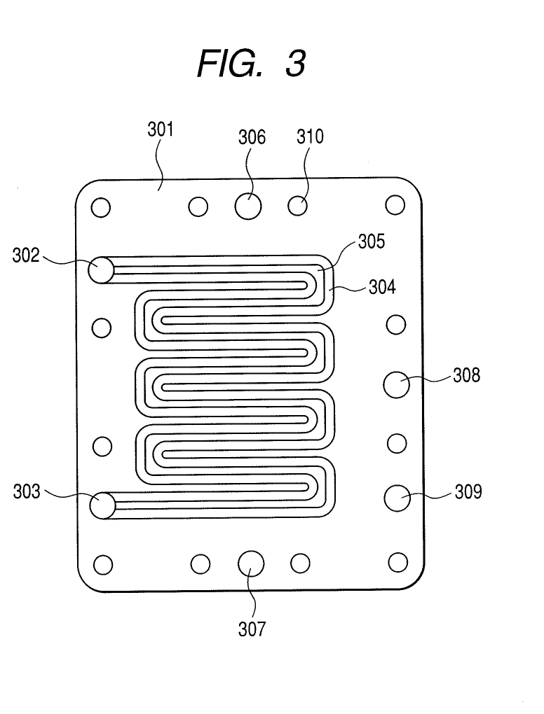

FIG. 3 shows a structure of a separator having flow passages for cooling water.

Cooling water is fed from an entrance manifold 303 to the surface of the separator and enters the flow passages for cooling water 304. The cooling water, as it flows, deprives of heat generated by electric power generation and arrives at an exit manifold 302 for cooling water; then it is discharged from the cell. Since the separator 301 for cooling water is stacked together with separators through which fuel gas and oxidizing gas flow, electric current in a direction perpendicular to the face of the separator for cooling water. In order to lower electric resistance, projections (ribs 305) are formed in the flow passages to secure contact areas between the separators.

There are formed along the periphery of the separator 301 an entrance manifold 306 for fuel gas, an exit manifold 307 for fuel gas, an entrance manifold 308 for oxidizing gas, an exit manifold 309 for oxidizing gas and 12 through holes 310 for bolts. The positions of the through holes are the same as in FIG. 1(b).

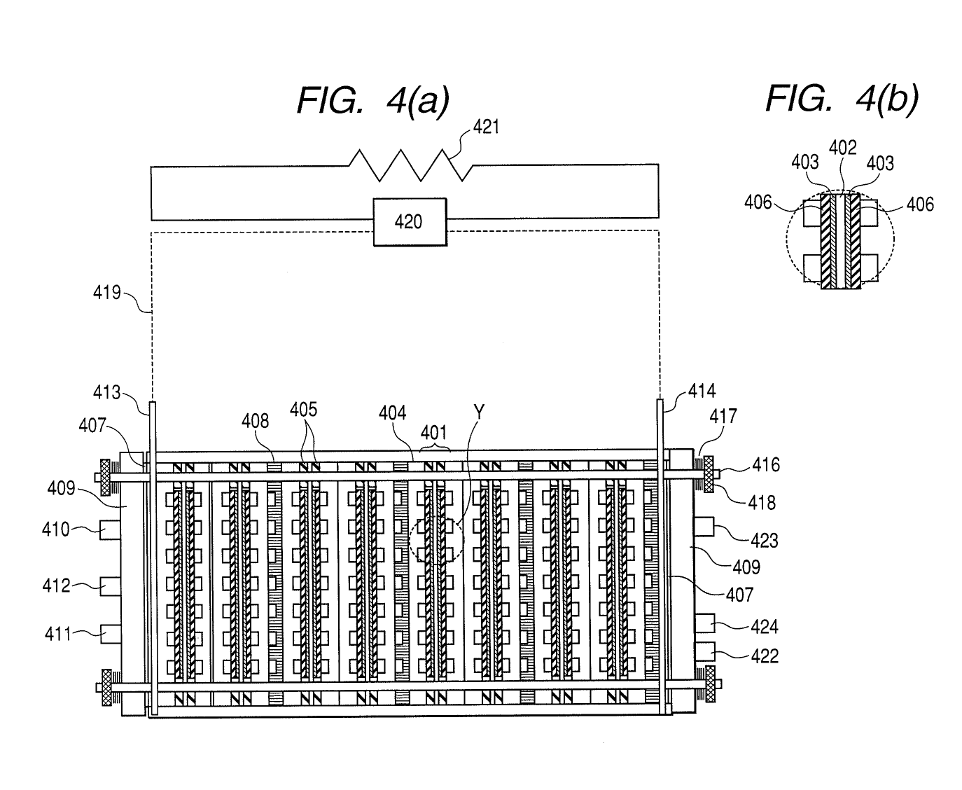

The cross sectional view of a fuel cell wherein the separators are installed therein is shown in FIG. 4(a). As shown in FIG. 4(b), which is an enlarged view of a circled portion Y in FIG. 4(a), a unit cell 401 comprises a membrane/electrode assembly (MEA), gas diffusion layers 406 and separators 404, the gas diffusion layers and the separators sandwiching the MEA, wherein MEA comprises electrolyte membrane 402 and catalyst layers 403 adhered to both faces of the membrane.

In order to prevent gas leakage, gaskets 405 are inserted into bonding faces of the separators. In order to remove heat generated during electric power generation, a separator 408 for cooling water is disposed.

The stack is fastened by end plates 409, bolts 416, plate springs 417 and nuts 418. Several fuel cells having different flow passage cross sectional area were assembled. One end of the end plate 409 was provided with pipe connector 410 for fuel gas (entrance), pipe connector 412 for oxidizing gas (entrance) and pipe connector 411 for cooling water (entrance). The other end plate 409 was provided with pipe connector 422 for fuel gas (exit), pipe connector 424 for oxidizing gas (exit) and pipe connector 423 for cooling water (exit).

A gasket 405, gas diffusion layer 406, membrane/electrode assembly, gas diffusion layer 406, gasket 405 were sandwiched between the fuel gas side separator 404 and oxidizing gas side separator 404 to constitute a unit cell. Thirty unit cells were stacked and the stack was sandwiched by insulating plates 407 and end plates 417. As power output terminals, collectors 413, 414 were disposed. A power cable 419 was connected to an inverter 420 for supplying electric power to external load 321. A rated voltage was 1 kW. This fuel cell is called E1.

Saturated air of 70 degrees Celsius was prepared by using a bubbler and it was supplied to the fuel cell E1. At the same time, saturated hydrogen of 70 degrees Celsius was supplied to the fuel cell E1. A preparatory operation of the fuel cell was conducted at a current density of 0.2 A/cm2. Since the electrolyte membrane is in a completely dry state just after assembly of the fuel cell, the membrane can be brought in a humid state after the preparatory operation. This is called an initial state. A cell voltage of the initial state was 0.72 V.

Then, operation of the fuel cell was continued so as to supply non-humidified air of 20 degrees Celsius to the fuel cell. After 10 hours have passed, an amount of water in the fuel cell became a normal value and water recycling was achieved. A cell voltage at this time was 0.70 V, which revealed that electric power generation was possible without a large voltage drop even if the non-humidified air is used.

For comparison, air was saturated at 50 degrees Celsius and electric power generation operation was conducted under the same conditions as the above mentioned, a cell voltage was 0.70 V. From this fact, it was revealed that the inside of the fuel cell was in the same state as air at the entrance was humidified to a dew point of 50 degrees Celsius saturation, i.e. the state was the same as saturated air of 50 degrees Celsius was supplied.

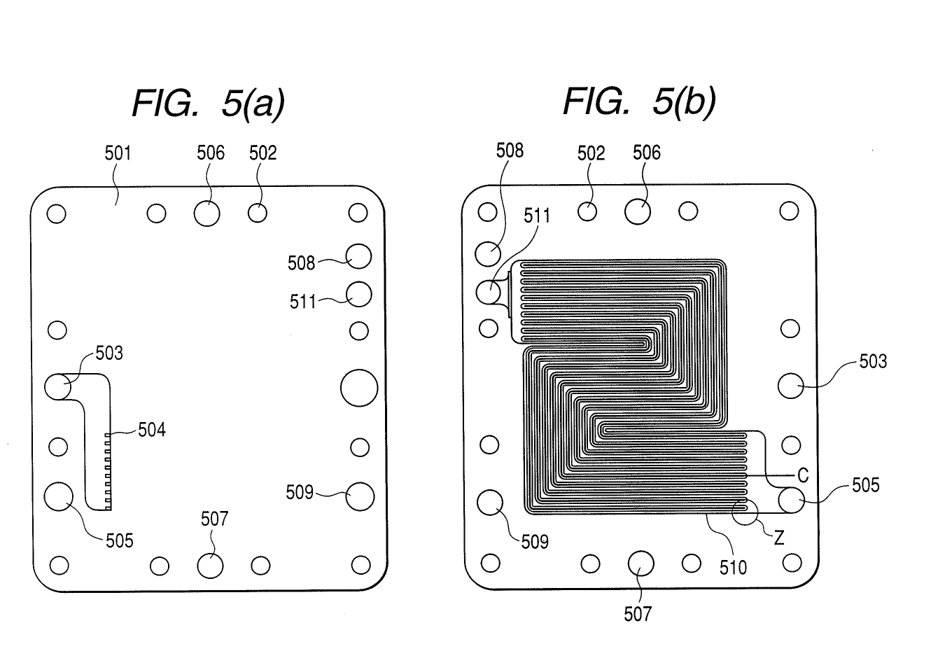

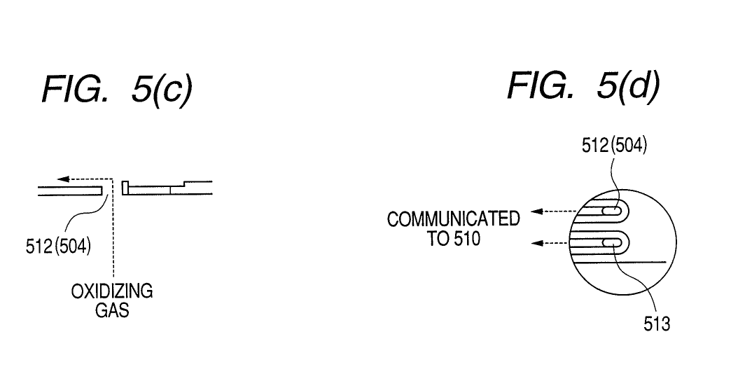

As a comparison, a fuel cell was assembled wherein separators 501 shown in FIGS. 5(a), and 5(b) having no returning point were used. In order to compare the fuel cell of the present invention with the comparative fuel cell under the same conditions, two entrance manifolds 503, 505 for oxidizing gas were formed; a groove width and groove depth of the flow passage 510 and shapes of small holes 512, ribs 513 were the same as in the E1.

Oxidizing gas flows along the flow passage 510 only in one direction and arrives at exit manifold 507 for oxidizing gas. The through holes 502 for inserting bolts and entrance manifold 509 for cooling water are arranged in the same way as in E1. Other components than the separators used were the same ones as in E1, and a rated voltage was 1 kW. This fuel cell is called E₂. In FIG. 1(a) to 1(d), the separator 501 is provided with small holes 504 for introducing oxidizing gas into the opposite face.

E₂ cell was subjected to preparatory operation under the same conditions of E1 to generate a cell voltage of 0.72 V. Thereafter, non-humidified air of 20 degrees Celsius was supplied to the cell. As a result, the cell voltage drastically dropped and increased; then, the cell voltage became zero at last, which was inoperable to generate electric power.

When saturated humid air of 50 degrees Celsius was supplied, the cell voltage was recovered to 0.69 V; however, the membrane/electrode assembly was damaged and the cell voltage became lower than that of E1.

What is claimed is:

1. A polymer electrolyte fuel cell comprising a first separators for oxidizing gas and a second separator for fuel gas and a membrane/electrode assembly sandwiched between the separators, wherein a first group of oxidizing gas flow passages flowing, from an entrance towards a turning point, having the longer length than a second group of oxidizing gas flow passages, from the turning point towards an exit, are formed on a plane of the first separator, wherein a downstream of the flow passages of the first group is located near an upper stream of the flow passages of the second, and wherein the flow passages of the first group and flow passages of the second group adjoin one another on the plane of the first separator.

2. The polymer electrolyte fuel cell according to claim 1, wherein the length of the first group of flow passages is defined by a length from the entrance for the oxidizing gas to the turning point and the length of the second group of flow passages is defined by a length from the turning point to the exit.

3. The polymer electrolyte fuel cell according to claim 1, wherein the manifold for the entrance and the manifold for the exit are disposed closely to each other.

4. The polymer electrolyte fuel cell according to claim 1, wherein the flow passages connected to the manifold for the entrance have a cross sectional area smaller than those of the manifold for the exit.

5. The polymer electrolyte fuel cell according to claim 1, wherein the oxidizing gas that flows out from the flow passages of the first group returns at a turning point and enters flow passages of the second group.

6. The polymer electrolyte fuel cell according to claim 1, wherein the flow passages adjoining the oxidizing flow passages have flows opposite to each other.

7. The polymer electrolyte fuel cell according to claim 1, wherein a groove width of the flow passages adjoining to the oxidizing flow passages at an upperstream is equal to or more than the width at downstream.

8. The polymer electrolyte fuel cell according to claim 2, wherein a groove width of the flow passages adjoining to the oxidizing flow passages at an upperstream is equal to or more than the width at downstream.

9. The polymer electrolyte fuel cell according to claim 1, wherein the flow passages for the fuel gas at downstream are superimposed on the flow passages for oxidizing gas at an entrance thereof.

10. The polymer electrolyte fuel cell according to claim 2, wherein the flow passages for the fuel gas at downstream are superimposed on the flow passages for oxidizing gas at an entrance thereof.

11. The polymer electrolyte fuel cell according to claim 3, wherein the flow passages for the fuel gas at downstream are superimposed on the flow passages for oxidizing gas at an entrance thereof.

12. The polymer electrolyte fuel cell according to claim 4, wherein the flow passages for the fuel gas at downstream are superimposed on the flow passages for oxidizing gas at an entrance thereof.

13. A separator for separating fuel gas from oxidizing gas, which includes a hole for introducing the oxidizing gas, an exit manifold for discharging the oxidizing gas, a plurality of flow passages communicating between the holes and the exit manifold, wherein two points between at least a pair of adjoining flow passages for oxidizing gas include portions where oxidizing gas with different humidity flows.

14. A separator for separating fuel gas from oxidizing gas, which includes holes for introducing the oxidizing gas, an exit manifold for discharging the oxidizing gas, and a plurality of flow passages communicating between the holes and the exit manifold, wherein two points between at least a pair of adjoining flow passages for oxidizing gas include portions where distances between the holes and the points are different.

15. A polymer electrolyte fuel cell comprising the separator defined in claim 10, a gas diffusion layer in contact with the surface of the separator where the flow passages for oxidizing gas are formed, and a cathode of a membrane/electrode assembly in contact with the gas diffusion layer.

16. A set of separators for a fuel cell one of which has a plurality of first flow passages for oxidizing gas having a turning point at a midpoint thereof and formed on one face thereof, wherein an exit of the flow passages is positioned neat an entrance of the first flow passages whereby the first flow passages at upper stream adjoin the flow passages in the downstream, and the other has a plurality of second flow passages for fuel gas, which are substantially straight and formed on one face thereof, wherein the exit and entrance of the first flow passages are located a position near an entrance of the second flow passages by means of a membrane/electrode assembly to be sandwiched between the pair of the separator.

17. A separator for a fuel cell having a plurality of flow passages for oxidizing gas, wherein the flow passages have a turning point at a midpoint thereof and formed on one face thereof, an exit of the flow passages is positioned near at an entrance of the flow passages whereby the flow passages at upper stream adjoin the flow passages in the downstream.
